(19) United States
(12) Patent Application Publication
(10) Pub. No.: US 2007/0285446 A1
(43) Pub. Date: Dec. 13, 2007

(54) Liquid consumption apparatus and liquid amount determination method

(75) Inventors: Satoshi Shinada, Shiojiri-shi (JP); Taku Ishizawa, Matsumoto-shi (JP); Masayoshi Katayama, Matsumoto-shi (JP); Noboru Asauchi, Yamagata-Vil (JP); Hideki Okumura, Shiojiri-shi (JP)

Correspondence Address: SUGHRUE MION, PLLC, 2100 Pennsylvania Avenue, N.W., Washington, DC, 20037, US

(73) Assignee: Seiko Epson Corporation, Shinjuku-ku (JP)

(21) Appl. No.: 11/808,311

(22) Filed: Jun. 8, 2007

(30) Foreign Application Priority Data
Jun. 8, 2006 (JP) 2006-159287

(51) Int. Cl. B41J 2/195

(52) U.S. Cl. 347/7

(57) ABSTRACT

The printer 10 executes an ink end detection process A while a print job is underway and an ink end detection process B when a print job has been completed. In the ink end detection process A, the printer 10 applies a first drive signal to detect that the amount of ink housed in the ink cartridge CA is equal to or less than a prescribed amount. In the ink end detection process B, the printer 10 applies a second drive signal to detect that the amount of ink housed in the ink cartridge CA exceeds the prescribed amount.

### BACKGROUND OF THE INVENTION

1. Field of the Invention

The present invention relates to a liquid consumption apparatus that consumes liquid as well as to a method to determine the amount of liquid inside the liquid consumption apparatus.

2. Description of the Related Art

A technology to manage the amount of liquid consumed by a liquid consumption apparatus that consumes liquid is known. For example, a printer in which one or more ink cartridges are mounted and that performs printing using ink is known as one type of liquid consumption apparatus, for example. Known technologies to determine that the printer has run out of ink include a technology that counts the number of ink droplets discharged from the print head and a technology that uses a liquid level sensor to determine whether or not the ink amount housed in the ink cartridge is equal to or less than a prescribed amount.

Using the technology that counts the number of ink droplets, because it is necessary to take into consideration errors regarding the amount housed in the ink cartridge and/or changes in ink droplet weight, it is difficult to increase the use efficiency for the ink housed in individual ink cartridges. At the same time, the problem exists that the remaining ink amount or ink consumption amount cannot be grasped until it is detected by the liquid level sensor that the ink amount has declined to a level that is equal to or less than the prescribed ink amount. Accordingly, a technology has been proposed that, using both the counting of the number of ink droplets and a liquid level sensor, corrects the count value representing the number of ink droplets to a prescribed value when the ink amount is detected by the liquid level sensor to be equal to or less than a prescribed ink amount.

### SUMMARY OF THE INVENTION

However, because detection of the ink amount by the liquid level sensor described above is not carried out while the ink is being consumed, such as during a printing operation or recovery operation, the problem of low detection accuracy persists. For example, when printing that consumes a large amount of ink is executed, the remaining ink amount may fall below the minimum liquid level detected by the liquid level sensor during printing, such that the accuracy of out-of-ink determinations cannot be improved even when a liquid level sensor is used.

The present invention was devised in order to address the problems described above, and an object thereof is to improve the accuracy of out-of-ink determinations.

In order to resolve at least part of the problems described above, a first aspect of the present invention provides a liquid consumption apparatus in which a liquid container that houses liquid can be mounted. The liquid consumption apparatus according to the first aspect of the present invention includes a liquid consumption module that consumes the liquid housed in the liquid container, a state determination module that determines the state of the liquid consumption apparatus, and a liquid amount determination module that determines, using one of at least two different types of determination processes depending on the state determined by the state determination module, whether or not the amount of liquid housed in the liquid container is equal to or less than a prescribed amount.

According to the first aspect of the present invention, it is determined whether or not the amount of liquid housed in the liquid container is equal to or less than a prescribed amount using one of at least two different types of determination processes depending on the state of the liquid consumption apparatus, therefore the accuracy of out-of-ink determinations may be improved.

In the liquid consumption apparatus according to the first aspect of the present invention, the states of the liquid consumption apparatus determined by the state determination module may include a first state that a liquid-consuming operation is being performed by the liquid consumption module and a second state that a liquid-consuming operation by the liquid consumption apparatus has been completed, and when the liquid consumption module is determined to be in the first state, the liquid amount determination module may use a first determination process to determine whether the amount of liquid housed in the liquid container is equal to or less than the prescribed amount, while when the liquid consumption module is determined to be in the second state, the liquid amount determination module may use a second determination process to determine whether the amount of liquid housed in the liquid container is equal to or less than the prescribed amount. By including this construction, the amount of liquid may be determined not only after the completion of a liquid-consuming operation but also during a liquid-consuming operation, the determination frequency may be increased, which improves the accuracy of determinations that the liquid container is out of ink.

In the liquid consumption apparatus according to the first aspect of the present invention, the first determination process executed by the liquid amount determination module may be executed via detection of whether the amount of liquid housed in the liquid container is equal to or less than the prescribed amount. By including this construction, the amount of liquid may be quickly determined without hindering the liquid-consuming operation.

In the liquid consumption apparatus according to the first aspect of the present invention, the liquid amount determination module may execute, when it is determined via the first determination process that the amount of liquid housed in the liquid container is equal to or less than the prescribed amount, a third determination process that detects whether the amount of liquid housed in the liquid container exceeds the prescribed amount. By including this construction, accuracy in determining the amount of liquid may be further improved.

In the liquid consumption apparatus according to the first aspect of the present invention, the second determination process executed by the liquid amount determination module may be executed via detection of whether or not the amount of liquid housed in the liquid container is equal to or less than the prescribed amount as well as detection of whether or not the amount of liquid housed in the liquid container exceeds the prescribed amount. By including this construction, it becomes possible to take time for the determination of the amount of liquid after the completion of a liquid-consuming operation, and accuracy in determining the amount of liquid may be improved.

In the liquid consumption apparatus according to the first aspect of the present invention, the liquid container may include a detector that detects whether or not the amount of liquid housed in the liquid container is equal to or less than a prescribed amount, the liquid amount determination module may further include a detector drive module that drives the detector and obtains results of the detection and can output a first drive signal to detect that the amount of liquid housed in the liquid container is equal to or less than the prescribed amount as well as a second drive signal to detect that the amount of liquid housed in the liquid container exceeds the prescribed amount, and the first determination process executed by the liquid amount determination module may be executed via the output of the first drive signal from the detector drive module to the liquid container. By including this construction, the accuracy of determinations that the liquid container is out of ink may be improved using the detector included therein.

In the liquid consumption apparatus according to the first aspect of the present invention, the liquid amount determination module may execute, when it is determined via the first determination process that the amount of liquid housed in the liquid container is equal to or less than the prescribed amount, a third determination process in which the detector drive module outputs the second drive signal to the liquid container. By including this construction, liquid amount determination accuracy may be further improved.

In the liquid consumption apparatus according to the first aspect of the present invention, the second determination process executed by the liquid amount determination module may be executed via the output of the first drive signal and the second drive signal to the liquid container from the detector drive module. By including this construction, it becomes possible to take time for the determination of the amount of liquid after the completion of a liquid-consuming operation, and liquid amount determination accuracy may be further improved

In the liquid consumption apparatus according to the first aspect of the present invention, the liquid consumption apparatus may include an ink jet printer that includes a liquid container comprising an ink container and has a carriage that moves along the main scanning direction, the liquid consumption module may be a print head that is mounted to the carriage and discharges the ink inside the ink container onto a printing medium while moving along the main scanning direction, the first state may be a state in which a print job is underway, the second state may be a state in which a print job has been completed, the ink container may include a detector that detects whether or not the amount of ink housed in the ink container is equal to or less than a prescribed amount, the liquid amount determination module may further include a detector drive module that drives the detector and obtains the results of the detection and that may output a first drive signal to detect that that the ink amount housed in the ink container is equal to or less than the prescribed amount and a second drive signal to detect that the ink amount housed in the ink container exceeds the prescribed amount, and the first determination process executed by the liquid amount determination module may be executed via the output of the first drive signal to the ink container from the detector drive module. By including this construction, the accuracy of determinations of the amount of ink housed in the ink container may be improved.

In the liquid consumption apparatus according to the first aspect of the present invention, when it is determined via the first determination process that the amount of liquid housed in the ink container is equal to or less than the prescribed amount, the liquid amount determination module may execute, without moving the carriage, a third determination process in which the detector drive module outputs the first drive signal and the second drive signal to the ink container. By including this construction, ink amount determination accuracy may be improved while minimizing or preventing hindrances to print job execution.

In the liquid consumption apparatus according to the first aspect of the present invention, the second determination process executed by the liquid amount determination module may be executed by moving the carriage to a prescribed position and having the detector drive module output the first drive signal and the second drive signal to the ink container. By including this construction, it becomes possible to take time for the determination of the amount of ink remaining after the completion of a print job, and the accuracy of determinations of the remaining ink amount may be further improved.

In the liquid consumption apparatus according to the first aspect of the present invention, the liquid amount determination module may further include detection module that detects whether or not the amount of liquid housed in the liquid container is equal to or less than a prescribed amount and may output to the liquid container a first detection signal to detect that the amount of liquid housed in the liquid container is equal to or less than the prescribed amount and a second detection signal to detect that the amount of liquid housed in the liquid container exceeds the prescribed amount, and the first determination process executed by the liquid amount determination module may be executed via the output of the first detection signal to the liquid container from the detection module. By including this construction, even where the liquid consumption apparatus includes detection module, the liquid amount determination accuracy may be improved.

In the liquid consumption apparatus according to the first aspect of the present invention, the second determination process executed by the liquid amount determination module may be executed via the output of the first detection signal and the second detection signal to the liquid container from the detection module. By including this construction, the liquid amount determination accuracy may be improved.

The second aspect of the present invention provides a liquid amount determination method for a liquid consumption apparatus in which a liquid container that houses liquid can be mounted. The liquid amount determination method according to the second aspect of the present invention includes determination as to whether the state of the liquid consumption apparatus is a first state in which a liquid-consuming operation is being performed by the liquid consumption module or a second state in which a liquid-consuming operation by the liquid consumption apparatus has been completed, wherein it is determined whether or not the amount of liquid housed in the liquid container is equal to or less than the prescribed amount using a first determination process when the liquid consumption module is determined to be in the first state, and using a second determination process that is different from the first determination process when the liquid consumption module is determined to be in the second state.

According to the second aspect of the present invention, the same operation as that obtained using the first aspect of the present invention may be obtained, and various embodiments are possible in the implementation thereof, as in the case of the liquid consumption apparatus according to the first aspect of the present invention.

The method according to the second aspect of the present invention may be also realized as a liquid consumption amount determination program for a liquid consumption apparatus, or as a computer-readable medium on which such program is recorded.

### BRIEF DESCRIPTION OF THE DRAWINGS

FIG. 1 is a drawing showing the basic construction of a printer pertaining to an embodiment;

FIG. 2 is a schematic front view of an ink cartridge pertaining to the embodiment;

FIG. 3 is a schematic side view of an ink cartridge pertaining to the embodiment;

FIG. 4 is an explanatory drawing schematically showing an ink cartridge pertaining to the embodiment mounted to the carriage;

FIG. 5 is an explanatory drawing showing the circuit construction for the terminals on the substrate in the embodiment;

FIG. 6 is an explanatory drawing showing via function blocks the internal construction of the control circuit used in the embodiment;

FIG. 7 is a flow chart showing the sequence of operations for the ink amount determination process executed in the printer pertaining to the embodiment;

FIG. 8 is a flow chart showing the sequence of operations for an ink end detection process A of this embodiment;

FIG. 9 is a flow chart showing the sequence of operations for an ink end detection process B of this embodiment;

FIG. 10 is a flow chart showing the sequence of operations for the ink end detection process B of this embodiment;

FIG. 11 is a flow chart showing the sequence of operations for an ink end detection process C of this embodiment;

FIG. 12 is a flow chart showing the sequence of operations for the ink end detection process C of this embodiment;

FIG. 13 is an explanatory drawing showing an example of the system construction when a personal computer is used as the ink amount management apparatus;

FIG. 14 is an explanatory drawing showing via function blocks the internal construction of the control circuit of another embodiment; and

FIG. 15 is an explanatory drawing showing an example of the construction of an ink cartridge CA.

### DESCRIPTION OF THE PREFERRED EMBODIMENTS

The liquid consumption apparatus and liquid consumption determination method pertaining to the present invention are described below based on embodiments and with reference to the drawings.

### A. Constructions of Printer and Cartridge

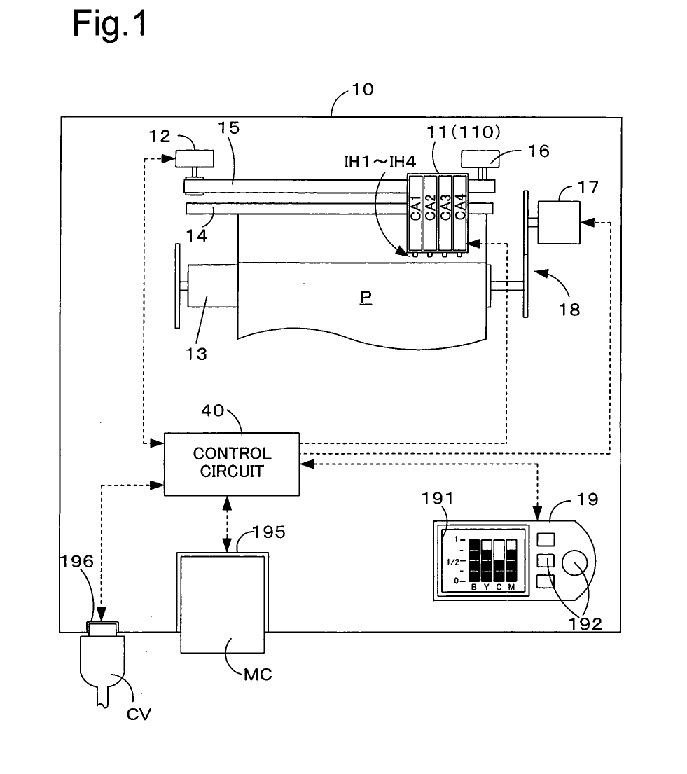

The basic construction of the printer pertaining to an embodiment is described below with reference to FIG. 1. FIG. 1 shows the basic construction of a printer 10 pertaining to the embodiment.

In this embodiment, the liquid consumption apparatus is described using a printer 10 as an example. The printer 10 includes a main scanning feed mechanism, a secondary scanning feed mechanism, a print head driving mechanism and a control circuit 40 that controls the driving of these mechanisms and executes various program functions governing the amount of consumption of ink, which comprises liquid.

The main scanning feed mechanism includes a carriage motor 12 that drives a carriage 11, a slide shaft 14 that is disposed parallel to the axis of the platen 13 and slidably supports the carriage 11, a pulley 16 that supplies tension to a looped driving belt 15 held between itself and the carriage motor 12, and a position sensor (not shown) that detects the home position of the carriage 11. The main scanning feed mechanism moves the carriage 11 back and forth along the axis of the platen 13 (i.e., the main scanning direction) via the carriage motor 12.

The carriage 11 includes a holder 110, print heads IH1-IH4 and a carriage circuit 1070 described below. The holder 110 is disposed on the top surfaces of the print heads IH1-IH4 and is constructed such that multiple ink cartridges CA1-CA4 can be mounted thereon. In the example shown in FIG. 1, four ink cartridges CA1-CA4 are mounted to the holder 110. For example, ink cartridges CA1-CA4 respectively housing ink of the four colors of black, yellow, magenta and cyan are mounted. The print heads IH1-IH4 and the ink cartridges CA1-CA4 are respectively connected to supply needles (not shown), such that the ink from the ink cartridges CA1-CA4 is supplied to the print heads IH1-IH4 through the respective ink supply needle.

The secondary scanning feed mechanism includes a paper feed motor 17 and a gear train 18. The secondary scanning feed mechanism conveys print paper P along the secondary scanning direction by transmitting the rotation of the paper feed motor 17 to the platen 13 via the gear train 18.

The head driving mechanism drives the print heads IH1-IH4 mounted to the carriage 11 and forms desired dot patterns on the print medium by controlling the amount and timing of ink discharge. The ink driving mechanism may comprise a driving mechanism that uses the deformation of a piezoelectric element that deforms via the application of voltage or a driving mechanism that uses air bubbles created in the ink by a heater that generates heat when voltage is applied thereto.

The control circuit 40 is connected to the carriage motor 12, the paper feed motor 17, the carriage circuit 1070 and an operation panel 19 via signal lines. The control circuit 40 is also connected to a memory card slot 195 and an I/O terminal 196 via signal lines and can be connected to a computer or a digital still camera via the I/O terminal 196. The control circuit 40 drives the carriage motor 12, paper feed motor 17 and print heads IH1-IH4 in accordance with instructions from a computer, the operation panel 190, or various programs stored in the control circuit 40.

The operation panel 19 includes a display panel 191 and operation keys 192. The display panel 191 is a color display panel that displays images or various information including ink amount information using dot matrix display having a prescribed resolution. The amounts of remaining ink in the ink cartridges CA1-CA4 are displayed on the display panel 191 in the form of a bar graph. A user interface (software keys) used to execute various functions regarding printing by the printer 10 is also displayed thereon. The operation keys 192 are used to input the selection of desired image data as well as input the selection and execution of various functions to the control circuit 40. Where the display panel 191 serves as an input panel as well, the various inputs may be performed using the display panel 191.

### Construction of Ink Cartridge

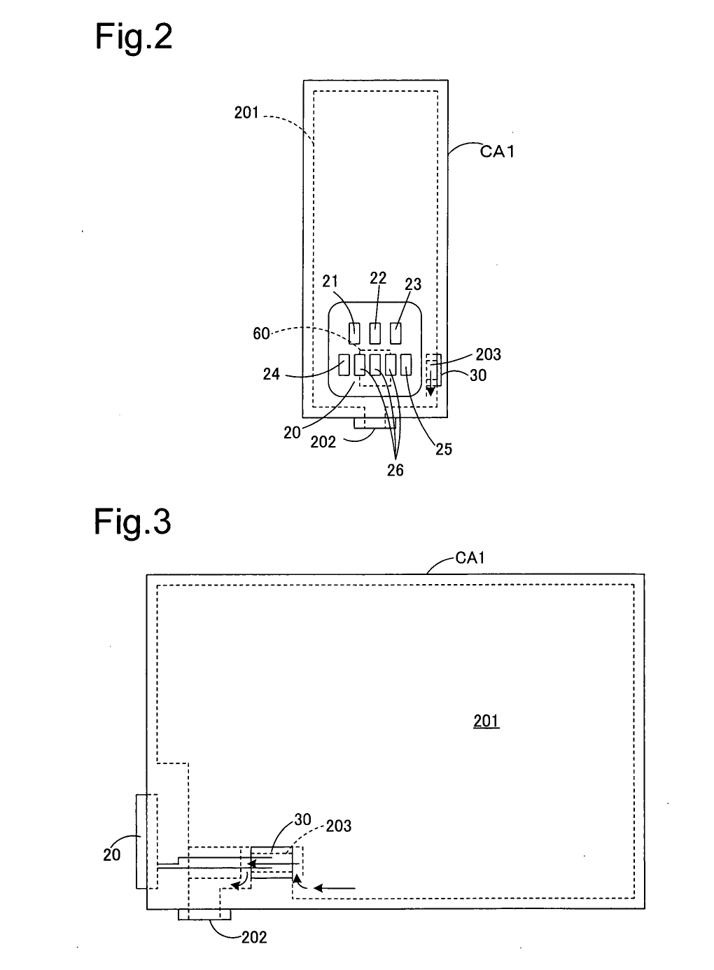

The construction of each ink cartridge pertaining to this embodiment will now be described with reference to FIGS. 2 and 3. FIG. 2 is a schematic drawing showing the front of an ink cartridge of this embodiment. FIG. 3 is a schematic drawing showing the side of an ink cartridge of this embodiment.

The ink cartridge CA1 will be described below as an example. The ink cartridge CA1 includes an ink container 201 that houses ink, an ink supply unit 202 that supplies the ink to the ink supply needle, a substrate 20 and an ink end sensor 30.

The ink container 201 and the ink supply unit 202 are connected via a connecting path 203 (see FIG. 3). The ink end sensor 30 is disposed in the connecting path 203. The ink end sensor 30 may be disposed such that it is in direct contact with the ink in the connecting path 203, or such that it is in indirect contact with the ink in the connecting path 203 via a member that can improve detection characteristics, for example. The ink end sensor 30 is electrically connected to terminals of the substrate 20.

The ink end sensor 30 comprises a piezoelectric element that deforms via the application of voltage and outputs voltage when it oscillates, for example. Because a piezoelectric element deforms when voltage is applied thereto and returns to a free state when the application of voltage is stopped, it can be caused to oscillate at a prescribed frequency by applying thereto a voltage of a prescribed drive signal. In this embodiment, a piezoelectric element is disposed in the connecting path 203, and the oscillation of the piezoelectric element can be deemed as the oscillation of the system that includes the connecting path 203 and the ink therein. When the application of voltage is stopped, a voltage signal that indicates the oscillation frequency of the system including the connecting path 203 and the ink therein is output from the piezoelectric element. Therefore, it can be determined whether or not a prescribed amount of ink exists in the ink cartridge CA based on the difference between the oscillation frequency detected when ink exists in the connecting path 203 (Full) and that detected when ink does not exist in the connecting path 203 (Empty).

Multiple terminals 21-26 are disposed on the substrate 20. The terminals 21-26 are electrically connected to the control circuit 40 by coming into contact with the terminals of the carriage circuit 1070 of the printer 10, as described below. The multiple terminals are, for example, a first cartridge-out detection terminal 21, a reference potential terminal 22, a second cartridge-out detection terminal 23, a first ink end sensor drive terminal 24, a second ink end sensor drive terminal 25 and a data terminal 26.

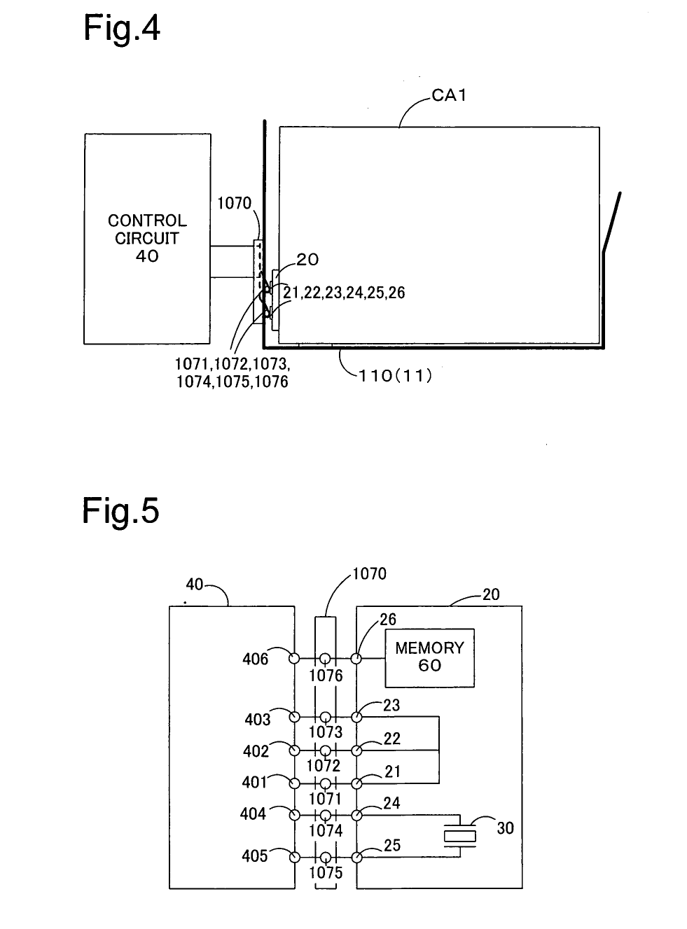

The terminals 21-26 included on the substrate 20 and the connection thereof with the carriage circuit 1070 will now be described with reference to FIGS. 4 and 5. FIG. 4 is an explanatory drawing that schematically shows the state in which an ink cartridge pertaining to this embodiment is mounted to the carriage. FIG. 5 is an explanatory drawing showing the circuit construction of each terminal on the substrate of this embodiment.

The carriage circuit 1070 includes contact pins 1071-1076 that come into contact with the terminals 21-26 of the substrate 20. The contact pins 1071-1076 are electrically connected to the terminals 401-406 of the control circuit 40. The contact pins 1071-1076 are, for example, a first cartridge-out detection pin 1071, a reference potential pin 1072, a second cartridge-out detection pin 1073, a first ink end sensor drive pin 1074, a second ink end sensor drive pin 1075 and a data pin 1076. The terminals 401-406 of the control circuit 40 are, for example, a first cartridge-out detection terminal 401, a reference potential terminal 402, a second cartridge-out detection terminal 403, a first ink end sensor drive terminal 404, a second ink end sensor drive terminal 405 and a data terminal 406.

While not in contact with the ink cartridge CA1, the tips of the contact pins 1071-1076 are disposed at positions further away from the carriage circuit 1070 than when in contact with the terminals 21-26 of the substrate 20 of the ink cartridge CA1. Therefore, when the ink cartridge CA1 is mounted to the holder 110 of the carriage 11, the contact pins 1071-1076 of the carriage circuit 1070 are pushed against the terminals 21-26 of the substrate 20 such that the terminals 21-26 become electrically connected to the contact pins 1071-1076.

The first cartridge-out detection terminal 21 and the second cartridge-out detection terminal 23 of the substrate 20 are directly connected to the reference potential terminal 22. The first ink end sensor drive terminal 24 and the second ink end sensor drive terminal 25 are connected to the ink end sensor 30. The data terminal 26 is connected to the memory 60.

A drive voltage to drive the ink end sensor 30 is input to either the first ink end sensor drive terminal 404 or the second ink end sensor drive terminal 405 when it is to be determined whether or not the ink amount in the ink container 201 is equal to or less than a prescribed level. As described below, the drive voltage is sufficiently higher than the detection voltage.

### Construction of Control Circuit

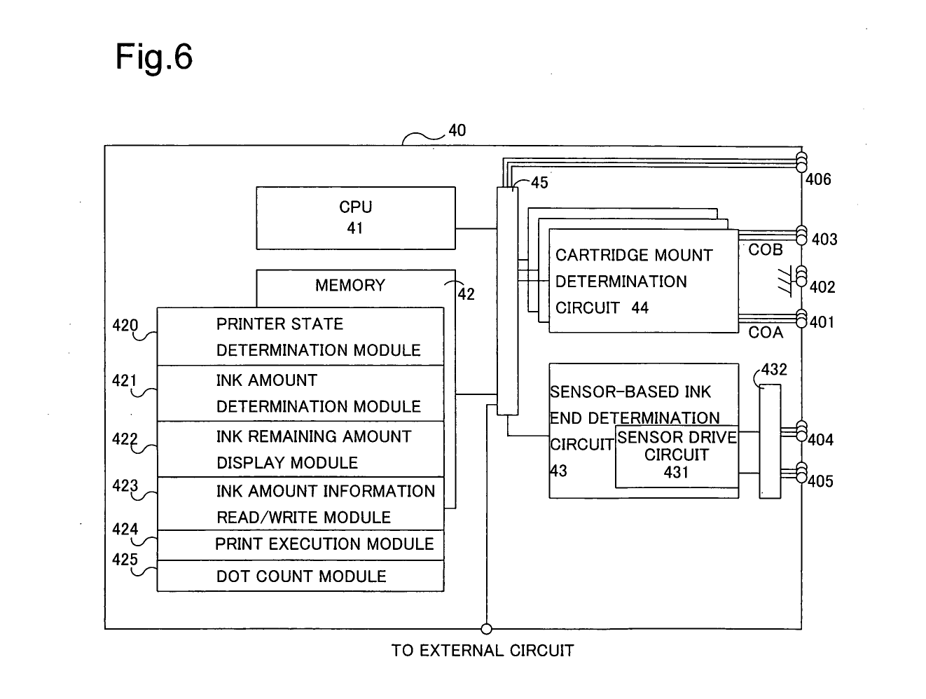

The functional internal construction of the control circuit 40 will now be described with reference to FIG. 6. FIG. 6 is an explanatory drawing showing via function blocks the internal construction of the control circuit 40 used in this embodiment.

The control circuit 40 includes a central processing unit (CPU) 41, a memory 42, a sensor-based ink end determination circuit 43, a cartridge mount determination circuit 44 and an I/O interface 45. The control circuit 40 includes terminals 401-406 that come into contact with the terminals of the carriage circuit 1070, as described above. In this embodiment, the description is provided using the terminals 401-406, sensor-based ink end determination circuit 43 and cartridge mount determination circuit 44 for one ink cartridge CA for the sake of simplification, but as shown in FIG. 6, the control circuit 40 includes multiple sets of terminals 401-406, a sensor drive circuit 431 and a cartridge mount determination circuit 44 that are used regarding the multiple ink cartridges CA.

The CPU 41, memory 42, sensor-based ink end determination circuit 43 and cartridge mount determination circuit 44 are connected to one another via the I/O interface 45 such that they can mutually communicate with one another. The I/O interface 45 is also connected to the external circuits such as the carriage motor 12 and the operation panel 19.

The control circuit 40 realizes the various function blocks via execution of the various programs stored in the memory 42 by the CPU 41.

The memory 42 stores, as the various programs necessary to execute ink amount determination processing, a printer state determination module 420, an ink amount determination module 421, an ink remaining amount display module 422, an ink amount information read/write module 423, a print execution module 424, and a dot count module 425. In addition, multiple drive frequencies that are used during driving of the ink end sensor 30 are stored in the memory 42. In this embodiment, the term ‘memory 42’ is used as a general term to refer to a non-volatile storage device to store the various programs and a volatile storage device used to execute the various programs.

The printer state determination module 420 is a program to determine the state of operation of the printer 20. In this embodiment, it is determined whether the state of operation of the printer 20 consists of a first state in which a print job is underway, a second state in which a print job has been completed, or a third state comprising any other state. In this embodiment, a post-page break state in which sensor-based detection that any of the ink cartridges CA is out of ink has been carried out during execution of a print job is referred to the third state. In this embodiment, the expression ‘a print job is underway’ is used to mean not only ongoing execution of printing but also ongoing execution of flushing, because in either process, ink droplets are discharged from the print heads IH1-IH4 based on raster data.

The ink amount determination module 421 is a module to determine based on the dot count value the ink amount, i.e., the percentage by weight or weight, for example, in an ink cartridge CA, and to execute sensor-based ink end detection. Different sensor-based ink end detection processes are executed depending on the state of operation of the printer 20 detected by the printer state determination module 420, such state being one of the three states of operation described above. Specifically, one of the sensor-based ink end detection processes comprising different combinations of (i) the types of drive signal sent to the ink end sensor 30, (ii) execution or non-execution of movement of the carriage 11 and (iii) execution or non-execution of flushing is carried out.

The ink remaining amount display module 422 is a program to generate ink remaining amount data that indicates the remaining amount of ink to be displayed on the display panel 191 and to display such amount on the display panel 191.

The ink amount information read/write module 423 is a program to write the dot count value counted by the dot count module 420 in the memory 60 of each ink cartridge CA1-CA4 at prescribed times or to read the dot count value stored in the memory 60 of each ink cartridge CA1-CA4.

The print execution module 424 is a program to form dot patterns on the print medium P using generated print data such that an image expressed by the print data is formed on the print medium P.

The dot count module 425 is a program to count the amount of ink consumption that occurs during an ink-consuming operation such as printing or flushing, and the obtained dot count value is written in the volatile storage device area of the memory 42.

The sensor-based ink end determination circuit 43 is a circuit to determine whether or not the ink amount in an ink cartridge CA1-CA4 is equal to or less than a prescribed amount in accordance with an instruction from the CPU 41. In this embodiment, the ink end sensor 30 to detect whether or not the ink amount in an ink cartridge CA1-CA4 is equal to or less than the prescribed amount is included in each ink cartridge CA1-CA4, and the sensor-based ink end determination circuit 43 includes a sensor drive circuit 431 to drive the ink end sensor 30. When multiple ink cartridges CA are mounted in the printer 10, the connection between the sensor drive circuit 431 and the ink end sensor drive terminals, i.e., the terminals 404 and 405, for example, may be switched, or alternatively, the same number of sensor drive circuits 431 as the number of ink cartridges CA may be included.

The sensor drive circuit 431 is connected to the first and second ink end sensor drive terminals 404, 405, and applies a drive voltage of a prescribed signal (drive signal) to either the first ink end sensor drive terminal 404 or the second ink end sensor drive terminal 405 in accordance with an instruction from the sensor-based ink end determination circuit 43. In this embodiment, as the drive signal, a drive signal to detect that an ink amount equal to or exceeding a prescribed amount remains in the ink container 201 (hereinafter the ‘Full’ signal) or a drive signal to detect that an ink amount less than the prescribed amount remains in the ink container 201 (hereinafter the ‘Empty’ signal) is used. The expression ‘an ink amount equal to or exceeding the prescribed amount remains in the ink container 201 of the ink cartridge CA’ means that the connecting path 203 is filled with ink, while the expression ‘an ink amount less than the prescribed amount remains in the ink container 201 of the ink cartridge CA’ means that no ink exists in the connecting path 203.

The drive voltage used for the detection of the sensor-based ink end is higher than the detection voltage used for the detection of mounting of an ink cartridge CA1-CA4, and is approximately 40V, for example. In this embodiment, a piezoelectric element is used as the ink end sensor 30, as described above. The detection of the sensor-based ink end is described in detail below in the description of the sensor-based ink end detection process, which is executed, for example, after flushing (i.e., ink discharge used to clean the ink head) that is executed following the completion of a print job.

The sensor drive circuit 43 applies a drive voltage to the ink end sensor 30 via (i) the first ink end sensor drive terminal 404 or second ink end sensor drive terminal 405, (ii) the first ink end sensor drive pin 1074 or second ink end sensor drive pin 1075, and (iii) the first ink end sensor drive terminal 24 or second ink end sensor drive terminal 25. The ink end sensor to which a voltage is applied deforms due to the inverse piezoelectric effect.

After supplying the drive voltage to the ink end sensor 30, the sensor drive circuit 431 electrically separates the line to which the drive voltage was supplied, i.e., the first ink end sensor drive terminal 404, the first ink end sensor drive pin 1074, and the first ink end sensor drive terminal 24, for example, from the drive voltage supply. As a result, the potential accumulated in the ink end sensor 30 is discharged, and the ink end sensor 30 oscillates together with the system including the connecting path 203 and the ink therein. A detection result voltage (i.e., an inverse electromotive pressure) having an oscillation frequency of the system including the connecting path 203 and the ink therein that was excited by the oscillation of the ink end sensor 30 appears as the output signal of the ink end sensor 30.

The detection result voltage input to the sensor drive circuit 43 is input to the sensor-based ink end determination circuit 43, which detects the ink remaining amount by measuring the oscillation frequency thereof. In other words, the oscillation frequency of the detection result voltage represents the unique frequency of the system including the connecting path 203 and the ink therein that oscillates with the ink end sensor 30, i.e., the assembly components surrounding the ink end sensor 30 (i.e., the case, ink, etc.), and changes depending on the amount of ink remaining in the connecting path 203. Therefore, when the connecting path 203 is filled with ink, if the ‘Full’ signal drive voltage is applied, because it matches the unique frequency of the system including the connecting path 203 and the ink therein, a detection result voltage having a ‘Full’ frequency is obtained, but if the ‘Empty’ signal drive voltage is applied, because it does not match the unique frequency of the system including the connecting path 203 and the ink therein, a detection result voltage having a frequency different from the ‘Full’ frequency is obtained. It is also possible that a sufficiently large detection result voltage is not obtained. On the other hand, when the connecting path 203 is not filled with ink, if the ‘Empty’ signal drive voltage is applied, because it matches the unique frequency of the system including the connecting path 203 and the ink therein, a detection result voltage having an ‘Empty’ frequency is obtained, but if the ‘Full’ signal drive voltage is applied, because it does not match the unique frequency of the system including the connecting path 203 and the ink therein, a detection result voltage having a frequency different from the ‘Empty’ frequency is obtained. It is also possible that a sufficiently large detection result voltage is not obtained.

Therefore, it can be determined whether or not a sufficient amount of ink remains in the ink container based on the detection result voltage output from the ink end sensor 30 that is obtained by applying the ‘Full’ or ‘Empty’ signal drive voltage to the ink end sensor 30, i.e., based on whether or not the drive frequency used for the detection was measured.

‘Sensor-based ink end’ in this embodiment refers to a situation in which the ink has been consumed to a prescribed amount that is not zero. The ink end sensor 30 does not detect the ink amount remaining in the ink container 201, but detects whether or not the connecting path 203 is filled with ink, i.e., whether or not a prescribed amount of ink remains in the ink container 201.

The cartridge mount determination circuit 44 is a circuit to determine whether or not an ink cartridge CA is mounted to the holder 110 of the printer 10. The cartridge mount determination circuit 44 is connected to the first and second cartridge-out detection terminals 401, 403 via two signal lines COA, COB. A voltage from the detection power supply, i.e., a voltage of approximately 3V, for example, is applied to the first and second cartridge-out detection terminals 401, 403. The control circuit 40 further includes a reference potential terminal 402, which serves as a terminal used to determine whether or not a cartridge CA is mounted. Where multiple ink cartridges CA are mounted, the same number of cartridge mount determination circuits 44 as the number of the ink cartridges CA are included.

When the ink cartridge CA1 is properly mounted in the holder 110 of the carriage 11, the potential of the first cartridge-out detection terminal 401 becomes the potential of the reference potential terminal 402, i.e., the reference potential. If the ink cartridge CA1 is not properly mounted in the holder 110, the potential of the first cartridge-out detection terminal 401 becomes the potential of the detection voltage. Here, the reference potential may be the grounding potential (0V) or a prescribed voltage that is sufficiently lower than the detection voltage.

In this embodiment, in order to determine more accurately whether or not the ink cartridge CA1 is mounted, two cartridge-out detection terminals are included. When the ink cartridge CA1 is properly mounted in the holder 110, the potential of the second cartridge-out detection terminal 403 becomes the potential of the reference potential terminal 402, i.e., the reference potential, and if the ink cartridge CA1 is not properly mounted in the holder 110, the potential of the second cartridge-out detection terminal 403 becomes the potential of the detection voltage.

The cartridge mount detection circuit 44 may extract the detection signal as a logical high signal or a logical low signal using a comparator. For example, where a 2V detection reference voltage Vref is input to the negative input pin of the comparator and the potential of the first cartridge-out detection terminal 401 is input to the positive input pin of the comparator, the comparator 412 outputs a high signal (V COA=1) if the potential input to the positive input pin is higher than the potential input to the negative input pin, and outputs a low signal (V COA=0) if the potential input to the positive input pin is lower than the potential input to the negative input pin.

Therefore, because the potential of the first cartridge-out detection terminal 401 becomes the reference voltage (<Vref) when the ink cartridge CA1 is properly mounted to the carriage 11, the comparator 412 outputs a low signal (V COA=0). On the other hand, because the potential of the first cartridge-out detection terminal 401 becomes the detection voltage (>Vref) when the ink cartridge CA1 is not mounted to the carriage 11, the comparator 412 outputs a high signal (V COA=1).

When the V COA (V COB) is a high signal (Hi), the cartridge mount determination circuit 44 determines that the ink cartridge CA1 is not mounted or properly mounted to the carriage 11, and when the V COA (V COB) is a low signal (Lo), it determines that the ink cartridge CA1 is properly mounted to the carriage 11.

The I/O interface 45 is connected to the data terminal 406 that is used to write to or read from the storage elements of the ink cartridges CA1-CA4.

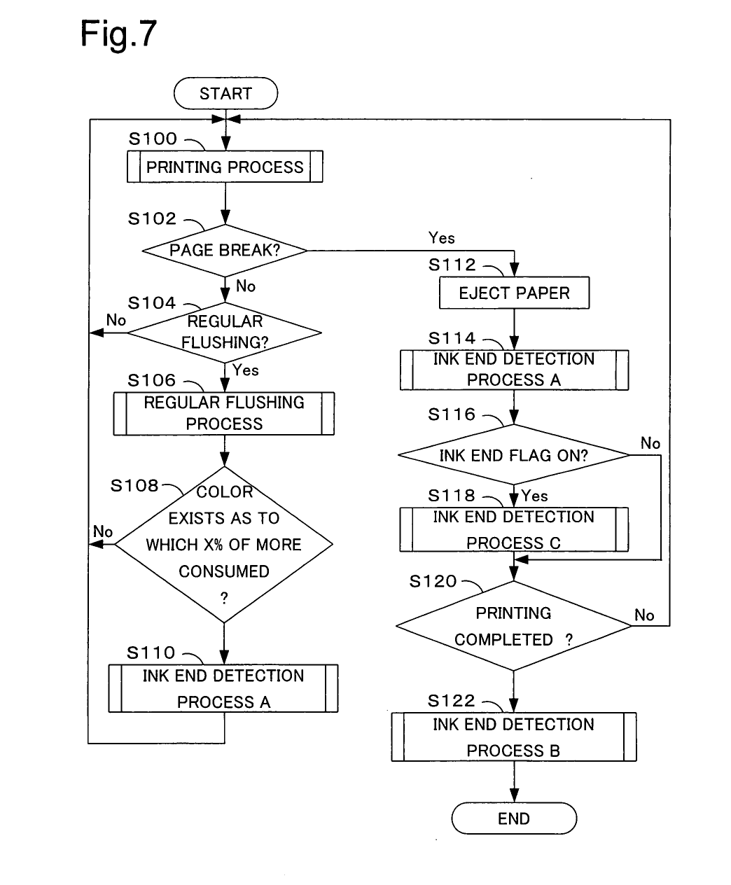

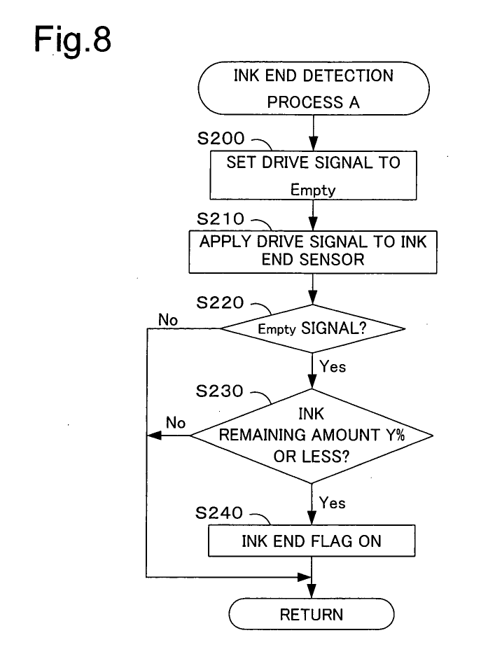

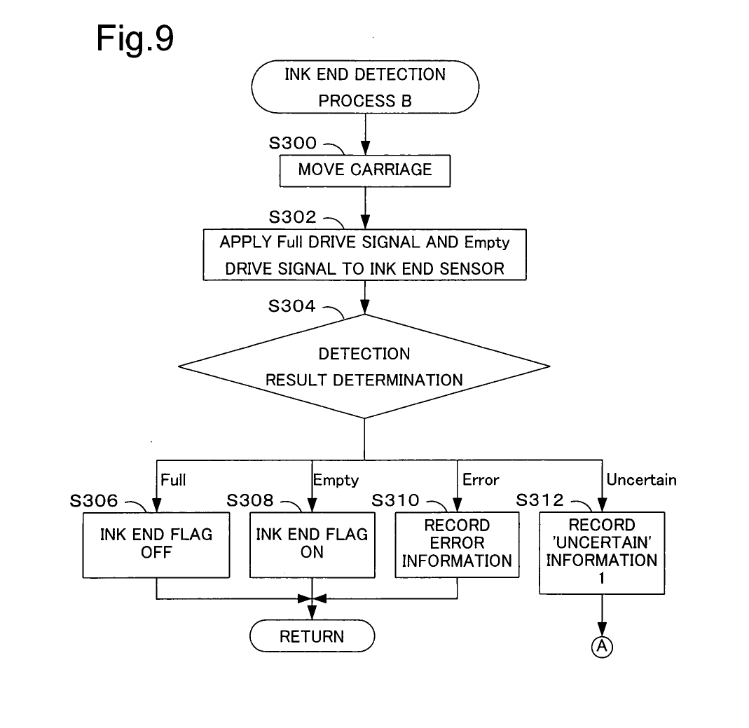

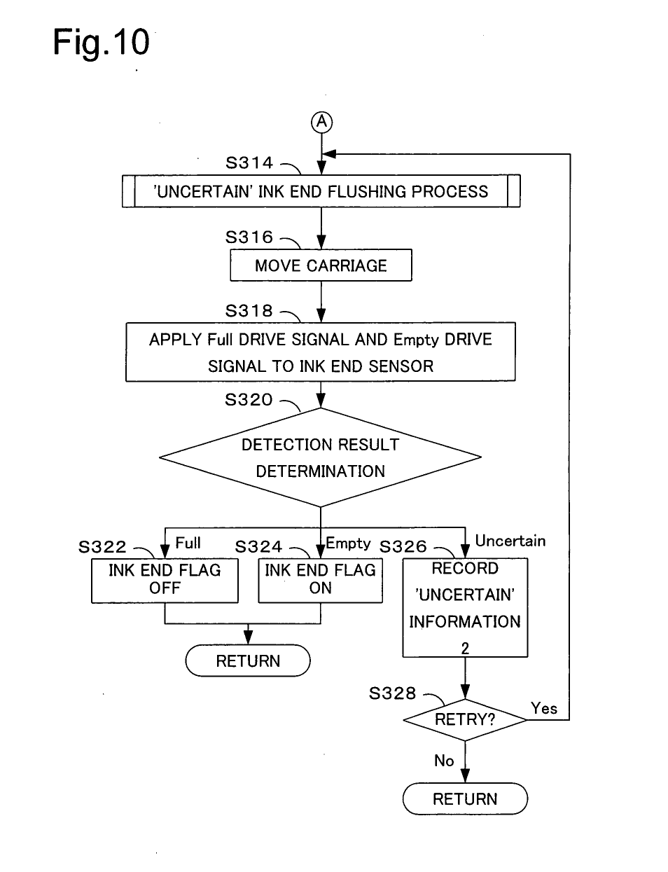

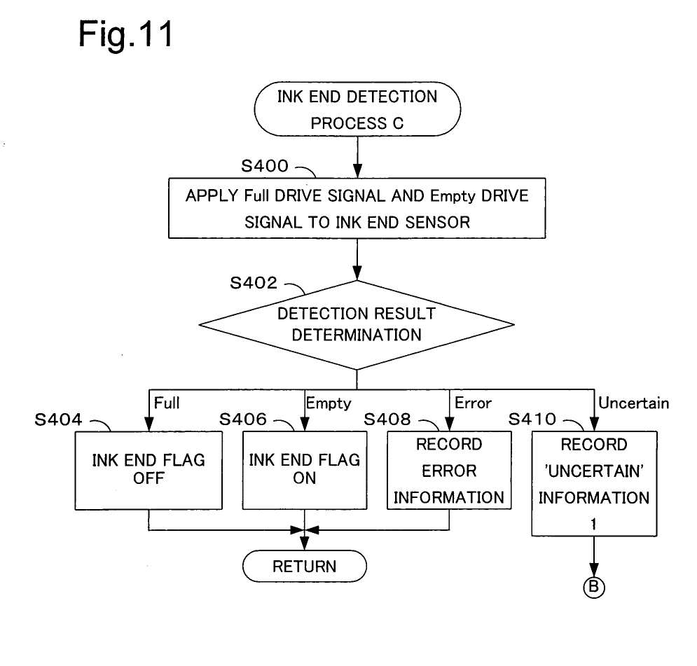

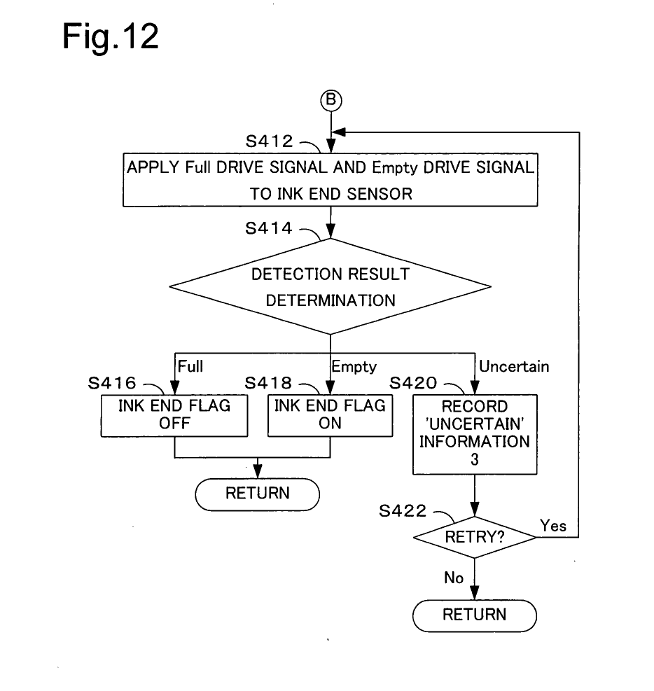

The ink amount determination process in this embodiment will now be described with reference to FIGS. 7 through 12. FIG. 7 is a flow chart showing the sequence of operations for the ink amount determination process executed by the printer pertaining to this embodiment. FIG. 8 is a flow chart showing the sequence of operations for the ink end detection process A in this embodiment. FIGS. 9 and 10 are flow charts showing the sequence of operations for the ink end detection process B in this embodiment. FIG. 11 and 12 are flow charts showing the sequence of operation for the ink end detection process C in this embodiment.

These sequences of operations are executed when printing is requested. The CPU 41 executes the requested printing (step S100). In the printing process, the CPU 41 generates based on image data that has been subjected to image processing, binarization or multi-value processing raster data that indicates the positions of dot formation (ON) and non-dot formation (OFF) along the main scanning direction, along which the print heads IH1-IH4 move, and that includes carriage return and page break commands.

Based on the generated raster data, the CPU 41 drives the carriage 11, platen 13, and print heads IH1-IH4 to form dot patterns that represent the image (text) by causing ink droplets to land at desired positions on the print medium P. The printing process ends when the print job, which comprises a single unit for purposes of the printing process, is completed.

The CPU 41 determines whether or not the raster data, which comprises the execution object, includes page break commands (step S102). If it is determined that no page break commands are included (No in step S102), the CPU 41 determines whether or not regular flushing is necessary (step S104). Regular flushing is executed periodically following a prescribed number of carriage returns or following the discharge of a prescribed number of ink droplets during the execution of printing in order to maintain print quality.

If it is determined that regular flushing is not necessary (No in step S104), the CPU 41 returns to step S100 and continues printing. On the other hand, if it is determined that regular flushing is necessary (Yes in step S104), the CPU 41 executes the regular flushing process (step S106).

In the regular flushing process, the CPU 41 moves the carriage 11 to the flushing position, and sends drive signals to the print heads IH1-IH4. As a result, ink droplets are discharged from the print heads IH1-IH4.

The CPU 41 determines if there are colors for which X% or more of ink has been consumed, or namely, ink cartridges CA for which X% or more of the initial amount has been consumed (step S108). In this embodiment, the ink amount discharged from each print head IH1-IH4 is counted as a dot count value (a percentage value or a weight value, for example) by the CPU 41. The CPU 41 counts the number of dots generated for each ink color based on the raster data. Where the print heads IH1-IH4 are capable of generating dots of various different diameters, such as small dots, mid-size dots and large dots, for example, the number of dots generated is counted for each dot diameter, and the dot count value is obtained by multiplying the each number of dots generated with a unit dot count coefficient predetermined for each dot diameter. Where there are multiple dot diameters, the unit dot count coefficient for a large dot or mid-size dot is given as a prescribed multiple of the unit dot count coefficient for a small dot, for example. It is also acceptable if, instead of the determination as to whether or not the remaining amount is X% (1%, for example), a determination is made as to whether or not the weight of the consumed ink is equal to or exceeds a prescribed weight, i.e. 0.1 g, for example.

If it is determined that there are no colors for which X% or more of ink has been consumed (No in step S108), the CPU 41 returns to step S100 and continues printing. If it is determined that there is a color for which X% or more of ink has been consumed (Yes in step S108), the CPU 41 executes the ink end detection process A (Step S110), returns to step S100, and continues printing. The ink end detection process A is described below.

If it is determined in step S102 that the target raster data includes a page return command (Yes in step S102), the CPU 41 controls the paper feed motor 17 to execute paper ejection (step S112). Paper ejection is carried out when the print job includes multiple pages as well as when the print job includes a single page only but the paper on which printing has been completed is to be ejected.

The CPU 41 executes the ink end detection process A after carrying out paper ejection (step S114). The CPU 41 determines whether or not the ink end flag, which indicates that sensor-based ink end has been detected, is ON (step S118). The ink end flag is recorded in the non-volatile area of the memory 42 as well as in the memory 60 of the ink cartridge CA1-CA4 in the ink end detection process A when sensor-based ink end has been detected and the dot count value is equal to or less than a prescribed value.

If it is determined that the ink end flag is ON (Yes in step S116), the CPU 41 executes the ink end detection process C (Step S118) and determines whether or not printing has been completed, i.e., whether the print job has been completed (step S120). The ink end detection process C is described below.

If it is determined that the ink end flag is not ON (No in step S116), the CPU 41 skips the ink end detection process C and determines whether or not printing has been completed (step S120).

If it is determined that printing has not been completed (No in step S120), the CPU 41 returns to step S100 and continues printing. For example, this applies to the situation in which the print job includes multiple pages.

If it is determined that printing has been completed (Yes in step S120), the CPU 41 executes the ink end detection process B (step S122), and ends these routines. The ink end detection process B is described below.

The ink end detection process A will now be described with reference to FIG. 8. The ink end detection process A is executed while printing is underway, and must be executed and completed quickly so that it does not hinder the printing process. Therefore, the ink end detection process is executed without moving the carriage 11 to the home position or ink end detection position, where it is less subject to noise.

The CPU 41 sets the ‘Empty’ drive signal as the drive signal to be applied to the ink end sensor 30 (step S200). By setting the ‘Empty’ drive signal as the drive signal, the erroneous detection of an ‘Empty’ state can be avoided. In other words, if the ‘Empty’ drive signal is applied to the ink end sensor 30 and ‘Empty’ is detected by mistake even though ink still remains in the connecting path 203, an ‘Empty’ state is not erroneously determined. Therefore, the fact that a prescribed amount or more of ink remains in the ink cartridge CA can be determined more accurately.

The CPU 41 requests that the sensor-based ink end determination circuit 43 output the drive signal to the ink end sensor 30 (step S210). The sensor-based ink end determination circuit 43 outputs the ‘Empty’ drive signal to the ink end sensor 30 via the sensor drive circuit 431.

The sensor-based ink end determination circuit 43 extracts the oscillation frequency component from the detection result signal output from the ink end sensor 30, and determines whether or not the extracted oscillation frequency is within the ‘Empty’ frequency range (step S220). If the extracted frequency is within such range, it can be regarded as an ‘Empty’ frequency. If it is determined that the detection result signal does not indicate an ‘Empty’ frequency (No in step S220), the CPU 41 determines that a prescribed amount or more of ink remains in the ink cartridge CA, and returns to the main routine shown in FIG. 7.

If it is determined that the detection result signal indicates an ‘Empty’ frequency (Yes in step S220), the CPU 41 determines whether or not the ink remaining amount is equal to or less than Y% based on the dot count value (step S230). For example, it is determined whether or not the ink remaining amount is equal to or less than 20%. If it is determined that the ink remaining amount exceeds Y% (No in step S230), the CPU 41 determines that the ink cartridge CA has not reached the ink end, and returns to the main routine shown in FIG. 7.

If it is determined that the ink remaining amount is equal to or less than Y% based on the dot count value (Yes in step S230), the CPU 41 turns ON the ink end flag (step S240), and returns to the main routine.

The ink remaining amount is taken into consideration in addition to the sensor-based ink end in the ink end detection process A in order to minimize detection errors by the ink end sensor 30. As described above, when making a sensor-based ink end determination, the ink end is determined to have been reached based on the frequency shown by the detection result signal, but because such determination is made while printing is underway, the result signal may include noise. By taking the dot count value into consideration, ink end determination accuracy is increased. It is also acceptable if the ink consumption amount is determined in place of the ink remaining amount, and remaining ink weight (or consumed ink weight) is used in place of a percentage value. For example, where the initial ink fill amount is 10 g, it may be determined whether or not the remaining ink weight is 2 g or less (i.e., the consumed ink weight is 8 g or more).

Where multiple ink cartridges CA1-CA4 are mounted, steps S210-S240 are repeated for each ink cartridge CA.

The ink end detection process B will now be described with reference to FIGS. 9 and 10. The ink end detection process B is executed after the completion of a print job, and therefore is a routine that can be executed with ample time. Therefore, when making a sensor-based ink end determination, the detection process is executed after the carriage 11 is moved to the home position or ink end detection position, where the carriage 11 is less subject to the influence of noise, and is stationary so there is minimal disturbance of the ink surface.

The CPU 41 moves the carriage 11 to the home position (step S300). Specifically, the CPU 41 controls the carriage motor 12 to move the carriage 11 to the home position. The home position is generally the position at which the carriage 11 is stored in a printer, and usually includes components used for flushing. This position is located at a distance from noise sources such as motors and control circuits. Where an ink end detection position at which little noise influence is received is separately available, the carriage 11 is moved to this ink end detection position instead of the home position.

The CPU 41 applies the ‘Full’ drive signal and the ‘Empty’ drive signal to the ink end sensor 30 via the sensor-based ink end determination circuit 43 (step S302). The sensor-based ink end determination circuit 43 determines whether the oscillation frequency of the detection result signal indicates ‘Full’, ‘Empty’, ‘Error’ or ‘Uncertain’ (step S304). If a signal indicating that the frequency of the detection result signal corresponding to the ‘Full’ drive signal is within the ‘Full’ frequency range, which means that the frequency can be deemed a ‘Full’ frequency, is received from the sensor-based ink end determination circuit 43, the CPU 41 determines that a prescribed amount or more of ink is in the ink cartridge CA, turns OFF the ink end flag (step S306), and returns to the main routine shown in FIG. 7.

If a signal indicating that the frequency of the detection result signal corresponding to the ‘Empty’ drive signal is within the ‘Empty’ frequency range, which means that the frequency can be deemed an ‘Empty’ frequency, is received from the sensor-based ink end determination circuit 43, the CPU 41 determines a prescribed amount or more of ink is not in the ink cartridge CA, i.e., that the cartridge CA is in the ink end state, turns ON the ink end flag (step S308), and returns to the main routine shown in FIG. 7.

If a signal indicating that no detection result signal was obtained either for the ‘Full’ drive signal or the ‘Empty’ drive signal is received from the sensor-based ink end determination circuit 43, the CPU 41 determines that an error occurred in the sensor-based ink end detection process, records error information in the non-volatile area of the memory 42 (step S310), and returns to the main routine shown in FIG. 7.

If a signal indicating that the detection result signal corresponding to the ‘Full’ drive signal does not fall within the ‘Full’ frequency range and that the detection result signal corresponding to the ‘Empty’ drive signal does not fall within the ‘Empty’ frequency range is received from the sensor-based ink end determination circuit 43, the CPU 41 determines that the ink cartridge CA is in an ‘Uncertain’ state in which the ink amount in the ink cartridge CA cannot be determined, and records ‘Uncertain’ information 1 in the non-volatile area of the memory 42 (step S312).

The CPU 41 executes the ‘Uncertain’ ink end flushing process (step S314). Flushing is executed as described above. For example, where bubbles are included in the ink in the connecting path 203 or ink exists only in some areas of the connecting path 203 due to the capillary phenomenon, the sensor-based ink end determination result may be indicated as ‘Uncertain’. Therefore, flushing is executed to eliminate these phenomena.

The CPU 41 moves the carriage 11 to the home position or the ink end detection position (step S316), and applies the ‘Full’ drive signal and the ‘Empty’ drive signal once more to the ink end sensor 30 via the sensor-based ink end determination circuit 43 (step S318).

The sensor-based ink end determination circuit 43 determines whether the oscillation frequency of the detection result signal indicates ‘Full’, ‘Empty’, ‘Error’ or ‘Uncertain’ (step S320). If the determination result from the sensor-based ink end determination circuit 43 is ‘Full’, the CPU 41 turns OFF the ink end flag (step S322) and returns to the main routine shown in FIG. 7.

If the determination result from the sensor-based ink end determination circuit 43 is ‘Empty’, the CPU 41 turns ON the ink end flag (step S324) and returns to the main routine shown in FIG. 7.

If the detection result from the sensor-based ink end determination circuit 43 is again ‘Uncertain’, the CPU 41 records ‘Uncertain’ information 2 in the non-volatile area of the memory 42 (step S326) and determines whether or not to perform retry (step S328). In this embodiment, the number of retries is predetermined, and is set to three, for example. Each time a retry is executed, an addition or subtraction is made to the number of retries. Once the number of retries reaches three or zero, the CPU 41 returns to the main routine shown in FIG. 7 without further execution of the sensor-based ink end process.

At the same time, the CPU 41 returns to step S314 until the number of retries reaches three or zero (Yes in step S328), executes the uncertain ink end flushing process, and repeats the execution of the sensor-based ink end routine comprising steps S316-S326.

Where multiple ink cartridges CA1-CA4 are mounted, steps S302-S328 are repeatedly executed for each ink cartridge CA. Steps S314-S328 that are executed when the ink end determination is ‘Uncertain’ may be executed only for ink cartridges CA as to which an ‘Uncertain’ determination was made, or for all ink cartridges CA. However, the carriage movement of step S316 is applicable to all ink cartridges CA1-CA4 because the operation applies to the entire carriage.

The ink end detection process C will now be described with reference to FIGS. 11 and 12. The ink end detection process C is executed when the printer 10 is in a state that is neither a state in which printing is underway nor a state in which printing has been completed. In this embodiment, the ink end detection process C is executed following the ink end detection process A when a page break is executed and when the ink end flag is ON. Therefore, because the time window within which the routine can be executed is shorter than when a routine is executed after the completion of a print job, the carriage 11 is not moved and the ‘Uncertain’ ink end flushing process is not carried out. Of the individual steps, those steps that are the same as the processing steps in the ink end detection process B will be only briefly explained.

The CPU 41 applies the ‘Full’ drive signal and the ‘Empty’ drive signal to the ink end sensor 30 via the sensor-based ink end determination circuit 43 (step S400). The sensor-based ink end determination circuit 43 determines whether the oscillation frequency of the detection result signal indicates ‘Full’, ‘Empty’, ‘Error’ or ‘Uncertain’ (step S402). Where the detection result of the sensor-based ink end determination circuit 43 is ‘Full’, the CPU 41 determines that a prescribed amount or more of ink is in the ink cartridge CA, turns OFF the ink end flag (step S404), and returns to the main routine shown in FIG. 7.

If the detection result of the sensor-based ink end determination circuit 43 is ‘Empty’, the CPU 41 determines that the ink end has been reached, turns ON the ink end flag (step S406), and returns to the main routine shown in FIG. 7.

If no detection result is obtained from the sensor-based ink end determination circuit 43, the CPU 41 determines that an error occurred in the sensor-based ink end detection process, records error information in the non-volatile area of the memory 42 (step S408), and returns to the main routine shown in FIG. 7.

If the detection result from the sensor-based ink end determination circuit 43 is neither ‘Full’ nor ‘Empty’, CPU 41 determines that the ink cartridge CA is in an ‘Uncertain’ state in which the ink amount in the ink cartridge CA cannot be determined, and records ‘Uncertain’ information 1 in the non-volatile area of the memory 42 (step S410).

The CPU 41 applies the ‘Full’ drive signal and the ‘Empty’ drive signal once more to the ink end sensor 30 via the sensor-based ink end determination circuit 43 (step S412).

The sensor-based ink end determination circuit 43 determines whether the oscillation frequency of the detection result signal indicates ‘Full’, ‘Empty’, ‘Error’ or ‘Uncertain’ (step S414). If the detection result from the sensor-based ink end determination circuit 43 is ‘Full’, the CPU 41 turns OFF the ink end flag (step S416) and returns to the main routine shown in FIG. 7.

If the detection result from the sensor-based ink end determination circuit 43 is ‘Empty’, the CPU 41 turns ON the ink end flag (step S418) and returns to the main routine shown in FIG. 7.

If the detection result from the sensor-based ink end determination circuit 43 is again ‘Uncertain’, the CPU 41 records ‘Uncertain’ information 2 in the non-volatile area of the memory 42 (step S420) and determines whether or not to retry (step S422). Because the given time window is small, the number of retries may be set to a smaller number than in the case of the ink end detection process B, i.e., one, for example. Once the number of retries reaches one or zero, the CPU 41 returns to the main routine shown in FIG. 7 without repeating the sensor-based ink end process (No in step S422).

At the same time, the CPU 41 returns to step S412 (Yes in step S422) until the number of retries reaches one or zero and executes the sensor-based ink end routine comprising steps S412-S422 once more.

Where multiple ink cartridges CA1-CA4 are mounted, steps S400-S433 are repeatedly executed for each ink cartridge CA. Steps S412-S422 that are executed when the ink end determination is ‘Uncertain’ may be executed only for ink cartridges CA as to which an ‘Uncertain’ determination was made, or for all ink cartridges CA.

As described above, using the printer 10 pertaining to this embodiment, different ink end detection processes are executed depending on the state of the printer 10. As a result, the frequency of ink end detection process execution can be increased, and ink end detection can be executed without hindering print jobs. Consequently, ink end determination accuracy can be improved.

In other words, in the prior art, an ink end detection process is executed only upon the completion of a print job, and therefore an out-of-ink situation cannot be detected on a real-time basis while a print job is underway. Therefore, a discrepancy occurs between the time at which a cartridge runs out of ink and the time at which such situation is detected, which makes it necessary to have a large ink end detection margin.

In contrast, the printer 10 pertaining to this embodiment can execute ink end detection while printing is underway without hindering a print job by executing the ink end detection process A that requires a short processing time. In addition, because the ink end detection process B that entails a longer detection process but has a higher detection accuracy is executed when the print job is completed, ink end detection with high ink end detection accuracy can be obtained.

Moreover, while a print job is underway, if a page break is executed or if the ink end flag is ON, the printer 10 pertaining to this embodiment can improve ink end detection accuracy by executing the ink end detection process C that is longer than the ink end detection process A but shorter than the ink end detection process B.

As described above, according to the printer 10 pertaining to this embodiment, ink end detection accuracy can be improved without reducing the speed of print job execution by executing an ink end detection process that is suited to the state of the printer 10.

### Other Embodiments

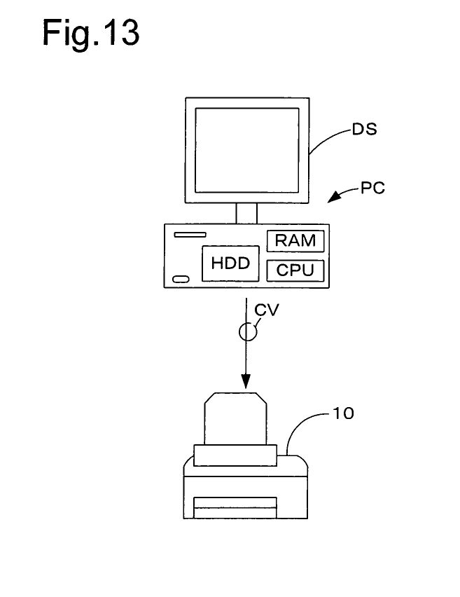

(1) The printer 10 was used as an example in the description of the embodiment, but as shown in FIG. 13, the ink remaining amount management process executed in the printer 10 may be implemented in a personal computer PC that is connected to the printer 10 via a connection cable CV. FIG. 13 is an explanatory drawing showing an example of a system construction in which a personal computer is the ink amount management apparatus. In this case, the ink remaining amount management process is executed by the printer driver stored on the hard disk drive (HDD), and the ink remaining amount is displayed as part of the display screen provided by the printer driver and displayed on the display device DS connected to the personal computer PC. The ink remaining amount management process pertaining to this embodiment can also be implemented in various other forms, including a printer driver and a computer-readable medium on which the printer driver is recorded, such as a CD-ROM and DVD-ROM.

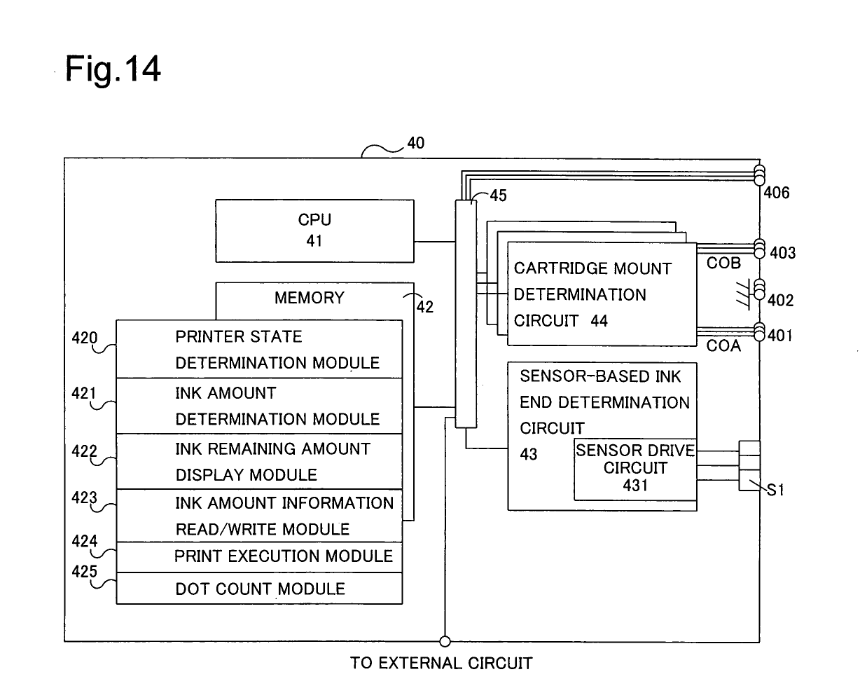

(2) In the embodiment described above, the ink end sensor 30 is included in each ink cartridge CA, but as shown in FIG. 14, it may be included in the printer 10. FIG. 14 is an explanatory drawing showing the internal construction of the control circuit of another embodiment using function blocks. For example, a detection window that can optically detect the ink level may be included in the ink cartridge, such that it is determined by an optical sensor S1 included in the printer 10 whether or not the ink level is equal to or exceeds a prescribed level. Using this construction, it can be determined whether or not the ink level is equal to or exceeds a prescribed level based on the difference in the amount of transmitted light or in the amount of reflected light between when ink exists in the detection window and when ink does not exist in the detection window.

(3) In the embodiment described above, a piezoelectric element is used as the sensor 30, wherein in a sensor-based ink end determination process, the control circuit 40 applies a drive voltage to the sensor 30 and the sensor 30 returns a response voltage (i.e., oscillation frequency) via electrical discharge, but any other type of sensor is acceptable as long as the sensor can return some type of response signal or response voltage in response to the input detection signal or drive voltage regardless of amount of the ink.

(4) In the embodiment described above, the sensor-based ink end determination circuit 42 is included in the printer 10, but the sensor-based ink end determination circuit 42 may be included in each ink cartridge CA.

(5) In addition, in the embodiment described above, the present invention was applied in ink cartridges CA and a printer 10 in which the cartridges are mounted, but the present invention may be applied in a different apparatus that consumes liquid, such as a liquid spray apparatus that sprays or expels paint or a layering material housed inside a cartridge. Liquid is consumed in this case as well, and the advantages obtained by managing the amount of consumed liquid can be obtained.

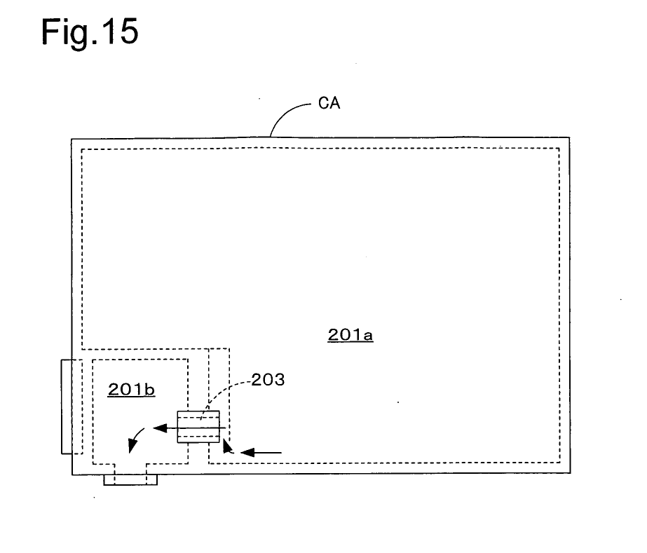

(6) The ink cartridges CA may have the construction shown in FIG. 15, for example. FIG. 15 is an explanatory drawing showing another example of the construction of an ink cartridge CA. In the embodiment described above, the ink cartridge CA has only one ink container, but it is also acceptable if the ink container comprises a main ink compartment 201a and a secondary ink compartment 201b. In this case, when the ink end sensor 30 detects the ink end, the amount that can be further printed by the printer can be easily set by adjusting the capacity of the secondary ink compartment 201b. In addition, because a prescribed amount of ink remains in the ink compartment 201b even after the ink end determination, blank printing can be avoided.

An ink end sensor 30 is disposed in the connecting path 203 that connects the main ink compartment 201a and the secondary ink compartment 201b in the same manner as in the embodiment described above. The connecting path 203 is a narrow passage in which capillary phenomena can occur, and air bubbles that enter the ink container 201 can be minimized or reduced. As a result, erroneous ink end detection can be avoided when air bubbles exist near the ink end sensor 30 while a sufficient amount of ink still remains in the main ink compartment 201a. At the same time, when the main ink compartment 201a runs out of ink, because a large number of air bubbles enter the connecting path 203, the ink end state, which should be detected, is detected by the ink end sensor 30.

(7) In the embodiment described above, retries are carried out during the ink end detection process C, but it is acceptable if the number of retries is set to zero, i.e., if no retries are carried out. Because the time window that can be used for an ink end detection process is short at the time of carriage return during execution of a print job, priority can be placed on print jobs by including this construction.

(8) In the embodiment described above, optimal drive signal information for the ink end sensor 30 is stored in the memory 60 of each ink cartridge CA, and a drive signal is set based on this drive signal information. Optimal drive signals are sought at the time of inspection prior to factory shipment, for example, and are stored in the memory 60. In this case, a general-purpose drive signal may be used during the ink end detection process A while an optimal drive signal stored in the memory 60 is used during the ink end detection process B, for example. This is because high detection accuracy cannot be expected during execution of a print job, but more accurate ink end detection is possible after the completion of a print job by using optimal drive signals.

(9) In the embodiment described above, the ‘Empty’ drive signal and the ‘Full’ drive signal are applied to the ink end sensor 30 during the ink end detection process C, but it is acceptable if only the ‘Full’ drive signal is applied thereto instead. Time can be saved by using the detection result from the ink end detection process A, which is performed using the ‘Empty’ drive signal immediately before the ink end detection process B.

The present invention was described above based on an embodiment and examples, but such embodiment and examples were used in order to facilitate understanding of the present invention, and do not limit the present invention in any way. The present invention can be modified and improved without deviating from the essence and claims thereof, and the present invention includes its equivalents as well. The present application claims the priority based on Japanese Patent Application No. 2006-159287 filed on Jun. 8, 2006 is herein incorporated by reference.

What is claimed is:

1. A liquid consumption apparatus in which a liquid container that houses liquid is mountable, comprising:
a liquid consumption module that consumes the liquid housed in the liquid container;
a state determination module that determines the state of the liquid consumption apparatus; and
a liquid amount determination module that, depending the state determined by the state determination module, determines, using one of at least two different types of determination processes, whether or not the amount of liquid housed in the liquid container is equal to or less than a prescribed amount.

2. The liquid consumption apparatus according to claim 1, wherein:
the states of the liquid consumption apparatus determined by the state determination module include a first state in which a liquid-consuming operation by the liquid consumption apparatus is underway and a second state in which a liquid-consuming operation by the liquid consumption apparatus has been completed; and
the liquid amount determination module determines whether the amount of liquid housed in the liquid container is equal to or less than a prescribed amount via a first determination process when the liquid consumption module is determined to be in the first state and via a second determination process that is different from the first determination process when the liquid consumption module is determined to be in the second state.

3. The liquid consumption apparatus according to claim 2, wherein the first determination process executed by the liquid amount determination module is executed via the detection of whether the amount of liquid housed in the liquid container is equal to or less than a prescribed amount.

4. The liquid consumption apparatus according to claim 3, wherein the liquid amount determination module further executes a third determination process that detects whether the amount of liquid housed in the liquid container exceeds the prescribed amount when it is determined in the first determination process that the amount of liquid housed in the liquid container is equal to or less than the prescribed amount.

5. The liquid consumption apparatus according to claim 2, wherein the second determination process executed by the liquid amount determination module is executed by detecting both whether the amount of liquid housed in the liquid container is equal to or less than the prescribed amount and whether the amount of liquid housed in the liquid container exceeds the prescribed amount.

6. The liquid consumption apparatus according to claim 2, wherein:
the liquid container includes a detector that detects whether the amount of liquid housed in the liquid container is equal to or less than the prescribed amount;
the liquid amount determination module further includes detector drive module that drives the detector and obtains the results of the detection and that is capable to output a first drive signal used to detect that the amount of liquid housed in the liquid container is equal to or less than the prescribed amount, as well as a second drive signal used to detect that the amount of liquid housed in the liquid container exceeds the prescribed amount; and
the first determination process executed by the liquid amount determination module is executed via the output of the first drive signal to the liquid container from the detector drive module.

7. The liquid consumption apparatus according to claim 6, wherein where it is determined in the first determination process that the amount of liquid housed in the liquid container is equal to or less than the prescribed amount, a third determination process in which the second drive signal is output by the detector drive module to the liquid container is executed.

8. The liquid consumption apparatus according to claim 6, wherein the second determination process executed by the liquid amount determination module is executed via the output of the first drive signal and the second drive signal to the liquid container from the detector drive module.

9. The liquid consumption apparatus according to claim 2, wherein
the liquid consumption apparatus is an inkjet printer in which a liquid container including an ink container is mounted and which has a carriage that moves along the main scanning direction;
the liquid consumption module is a print head that is mounted to the carriage and discharges the ink inside the ink container onto a printing medium while moving along the main scanning direction;
the first state is a state in which a print job is being executed and the second state is a state in which print job execution has been completed;
the ink container includes a detector that detects whether the amount of ink housed in the ink container is equal to or less than a prescribed amount;
the liquid amount determination module further includes a detector drive module that drives the detector and obtains the results of the detection and that can output a first drive signal used to detect that the amount of ink housed in the ink container is equal to or less than a prescribed amount, as well as a second drive signal used to detect that the amount of ink housed in the liquid container exceeds the prescribed amount; and
the first determination process executed by the liquid amount determination module is executed via the output of the first drive signal to the ink container from the detector drive module.

10. The liquid consumption apparatus according to claim 9, wherein where it is determined in the first determination process that the amount of ink housed in the ink container is equal to or less than the prescribed amount, the liquid amount determination module executes a third determination process in which the detector drive module outputs the first drive signal and the second drive signal without moving the carriage.

11. The liquid consumption apparatus according to claim 9, wherein the second determination process executed by the liquid amount determination module is carried out by moving the carriage to a prescribed position and having the detector drive module output the first signal and the second signal to the ink container.

12. The liquid consumption apparatus according to claim 2, wherein:
the liquid amount determination module further includes detection module that detects whether the amount of liquid housed in the liquid container is equal to or less than a prescribed amount and that is capable to output a first drive signal used to detect that the amount of liquid housed in the liquid container is equal to or less than the prescribed amount, as well as a second drive signal used to detect that the amount of liquid housed in the liquid container exceeds the prescribed amount; and
the first determination process executed by the liquid amount determination module is executed via the output of the first drive signal to the liquid container from the detection module.

13. The liquid consumption apparatus according to claim 12, wherein the second determination process executed by the liquid amount determination module is executed via the output of the first detection signal and the second detection signal to the liquid container from the detection module.

14. A liquid amount determination method for a liquid consumption apparatus in which a liquid container that houses liquid is mountable, the method comprising:
determining whether the state of the liquid consumption apparatus is a first state in which a liquid-consuming operation by the liquid consumption apparatus is underway or a second state in which a liquid-consuming operation by the liquid consumption apparatus has been completed; and
determining whether the amount of liquid housed in the liquid container is equal to or less than a prescribed amount via a first determination process when the liquid consumption apparatus is determined to be in the first state and via a second determination process that is different from the first determination process when the liquid consumption apparatus is determined to be in a second state.
